(19) United States
(12) Patent Application Publication
(10) Pub. No.: US 2017/0357642 A1
(43) Pub. Date: Dec. 14, 2017

(54) Cross Lingual Search using Multi-Language Ontology for Text Based Communication

(71) Applicant: Babel Street, Inc., Reston, VA (US)

(72) Inventors: Jeffrey Chapman, Landsowne, VA (US); Shon Myatt, Starkville, MS (US); James B. Haynie, New Orleans, LA (US)

(73) Assignee: Babel Street, Inc., Reston, VA (US)

(21) Appl. No.: 15/621,817

(22) Filed: Jun. 13, 2017

Related U.S. Application Data
(60) Provisional application No. 62/349,709, filed on Jun. 14, 2016.

(51) Int. Cl. G06F 17/28; G06F 3/01; G06F 17/30; G06F 17/22

(52) U.S. Cl. CPC G06F 17/289; G06F 3/018; G06F 17/30595; G06F 17/2223

(57) ABSTRACT

A method for conducting a cross lingual searching utilizing an ontology reference process to ensure thoroughness. When a query is entered, an ontology database is accessed to identify all representations for the parent entity of interest within specified languages. These representations are used to form a search set that results in more thorough collection from the data sources. Thus, the disclosed method accommodates situations where languages do not follow the same construct (e.g. English compared to Chinese) and where direct translation does not adequately represent the intent of the user's inquiry.

### CROSS REFERENCE TO RELATED APPLICATION

The present application claims priority to U.S. Provisional Patent Application No. 62/349,709, entitled “Cross Lingual Search using Multi-Language Ontology for Text Based Communication” and filed Jun. 14, 2017. The contents of U.S. 62/349,709 are hereby incorporated by reference herein in their entirety.

### FIELD OF INNOVATION

The subject matter of the present disclosure generally relates to electronic searching, and more particularly relates to improvements in electronic cross-lingual searching.

### BACKGROUND

All languages possess words, terms, and/or gestures that do not always translate neatly into other vernaculars. Often, even when a direct translation exists it may still contain errors due to sematic use, idioms, or the context of the expression when crossing languages. This reality creates difficulties when attempting to translate a single word across languages as multiple forms of the word within a single language can be relevant based on its use or purpose. Translating from character-based to pictographic (e.g. Chinese, Japanese, Korean) languages exacerbates these problems because there is no true character-for-character or word-for-word association available.

Current computer cross-lingual search systems utilize a single-source translation that converts the query, be it word, phrase, or gesture, into the appropriate language representation used in the text communication. Using this single source, the electronic search is thus limited just to the direct translation of the query, without taking into account semantics or lexicon. Thus, the translation of the query may not accurately account for the context of the original use. Existing computer processes limit the full scope of available sources of information since documents that do not contain the correct translated form of the word, phrase, or gesture of interest would not appear as a match, leaving the user unaware of the existence of search results of interest when search results are returned. This can severely limit the utility of current computer search systems.

### SUMMARY

Disclosed is a method and system for conducting cross lingual searching of text based communications using a multi-language ontology. In an embodiment, a word of interest is received and propagated through an ontology for multiple languages identifying all associations within a database to create a search set. For the purposes of the present disclosure, the term “WORD” will represent, without limitation, “words, phrases, gestures, slang terms, expressions, and pictographic representations.” The search set is composed of all representations for the parent entity for each language as a set of sub-sets (i.e., an individual sub-set for each language). The search is then performed using the search set to identify text-based communications containing some equivalent representation of the parent entity within the document's respective language. The resulting documents, containing WORDs within the search sets, are then indexed to correlate with the parent entity. The product is a set of documents containing one or more of the ontology search set entities for the parent word indexed back to the initial search entry for direct retrieval and future searching.

Discovery of key terms, phrases, or gestures within text based communication across multiple languages using an ontology based approach increases the effectiveness of searching compared to the use of direct single source translations. A multi-language ontology effectively represents each individual language's lexicon for the word of interest which allows for the creation of a search set. The use of the search set provides a larger breadth of searching capability compared to the use of a single direct translation. Once complete, the results are stored in an electronic database with an index to the parent entity to permit efficient retrieval and future searching. The method therefore accounts for subtle differences in semantics, vernacular, and dialect that may not transform accurately from a single source translation. Thus, the search identifies potential matches that may have otherwise been lost with the use of a preprocessed single word direct translation.

Using a multi-language ontology to represent multiple forms and related terms associated with a word of interest increases the effectiveness of cross lingual searching by expanding the body of available information that would otherwise be inaccessible for a direct single source translation. This ontology accommodates the use of a wide array of terms covering dialect, jargon, slang, contextual relationships, or gestures (including pictograph representations) in creating a search set. This will improve search capabilities by ensuring the semantic influences and context of the words are accurately represented in the search results for all languages of interest.

### BRIEF DESCRIPTION OF THE DRAWINGS

FIG. 1 illustrates sequential steps of an embodiment.

FIG. 2 provides a visual representation of an embodiment ontology search set creation for use in a cross lingual search.

FIG. 3 illustrates the conceptual flow of an embodiment conducting cross lingual ontological searching of a text based communication.

FIG. 4 illustrates the indexing of ontology matches within digital sources to the parent entity.

FIG. 5 illustrates a list of some equivalent representations of a parent entity as presented on a display for an example search using an embodiment.

FIG. 6 illustrates a list of other equivalent representations of a parent entity as presented on a display for an example search using an embodiment.

FIG. 7 illustrates a list of other equivalent representations of a parent entity as presented on a display for an example search using an embodiment.

FIG. 8 is a graphical depiction of the manner in which an ontology mapping is created for an entered search term in various languages.

FIG. 9 is a graphical depiction of the manner in which a document identified during searching is indexed to the original search term.

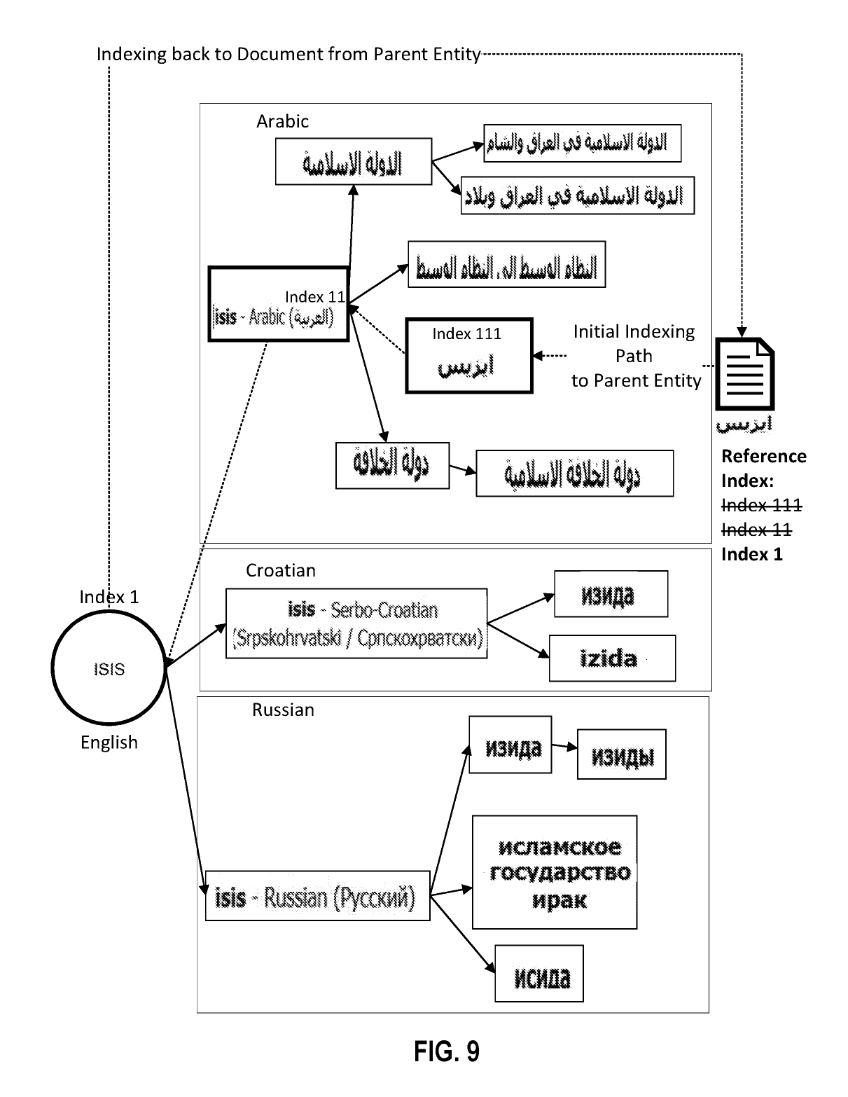

### DETAILED DESCRIPTION

Disclosed is a method for conducting cross lingual searches of electronic text based media for WORDs that accounts for the semantics and contextual differences across vernaculars. Embodiments utilize a multi-language ontology to establish a search set that will contain multiple forms and word relationships to the parent entity in the respective languages prior to conducting a search process. The end result is a set of documents that have one or more entries within the search set indexed to the parent entity.

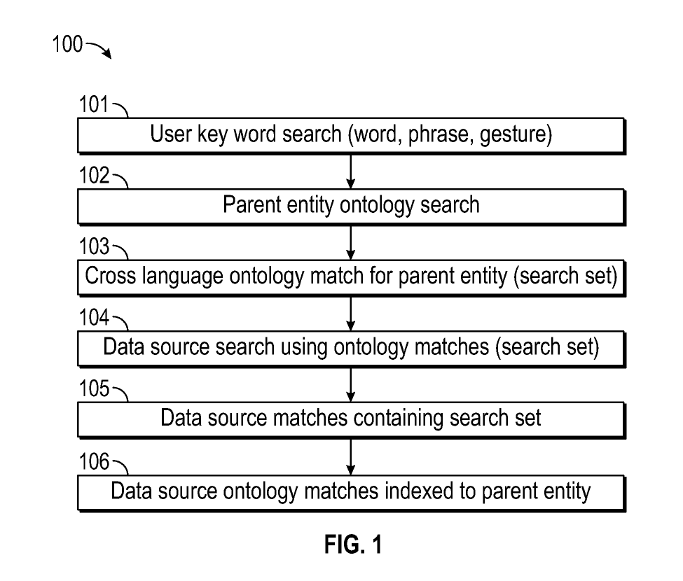

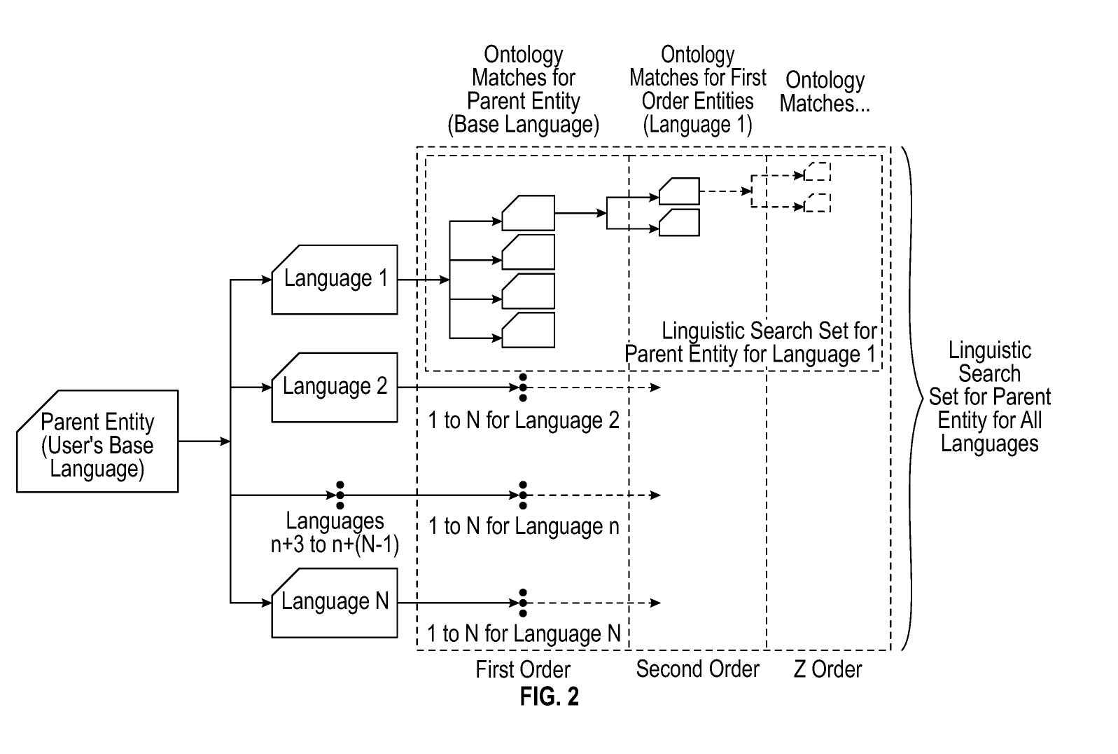

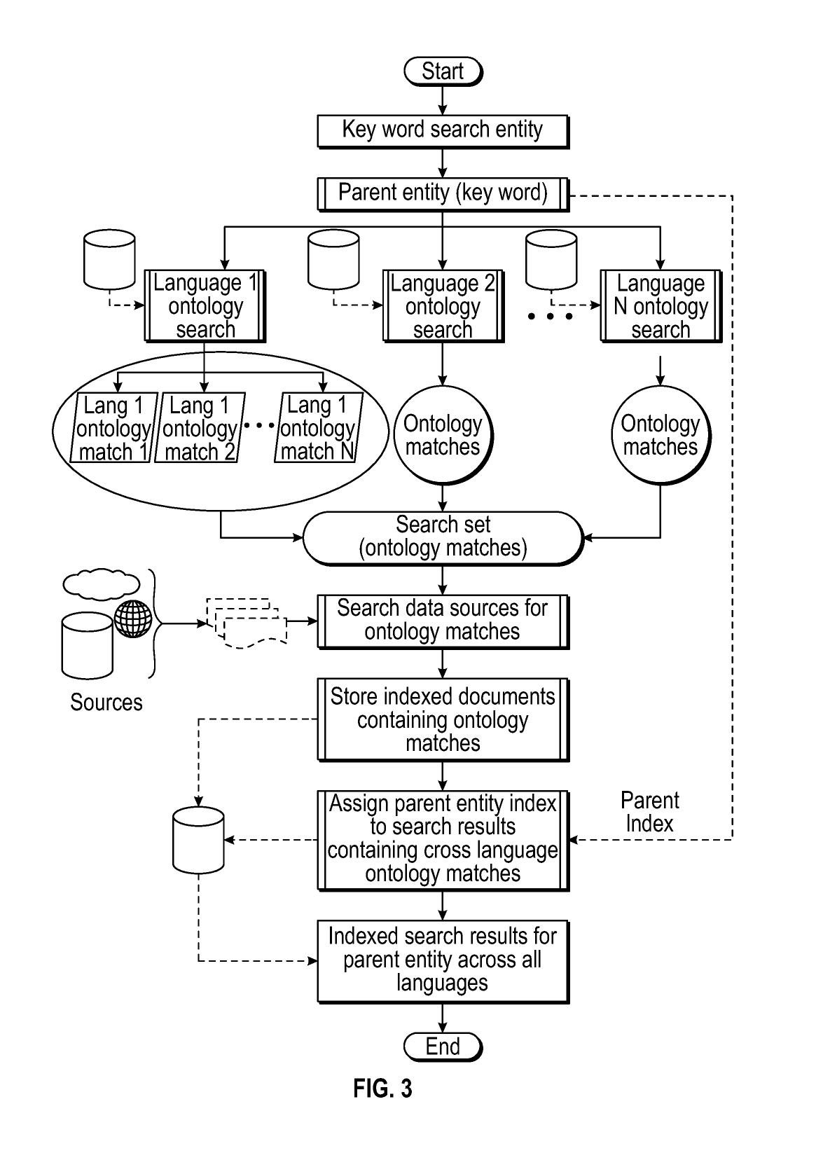

In an embodiment and with reference to FIGS. 1 and 2, the process initiates with the user entering the WORD (the parent entity) in step 101 to conduct a search of text based electronic media across multiple languages. The WORD is processed through its particular ontology in steps 102 and 103 to determine the associated representations in respective languages as seen in FIG. 2, which depicts the branching of word associations for each language. This includes non-direct translations, such as when an acronym has an expanded set of words associated with it or when a word has an equivalent representation that is only accurate in context. The results form the search set of WORDs. The ontology contains branches and sequels to ensure dialect, semantics, and contextual meanings are not lost in the translation. FIG. 3 depicts a conceptual flowchart for the process where the word of interest becomes the parent entity for each language.

This ontology becomes the search set, which is composed of all the associated WORDs collected from the individual language ontologies. The search set is thus a list of searchable terms used to process texted-based media.

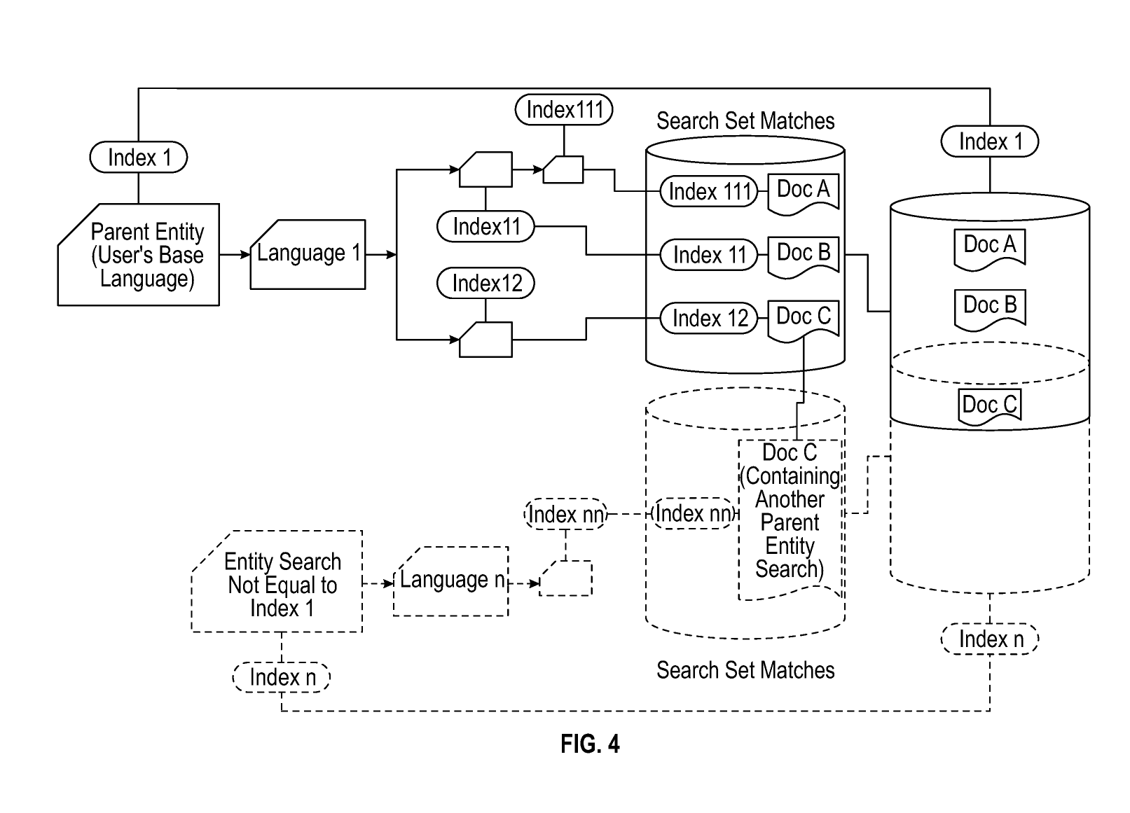

The process uses the search set to filter for ontology matches in steps 104 and 105 and then store the matching documents and index them to the parent entity in step 106. This indexing of results is depicted in FIG. 4.

After indexing, the documents are directly correlated to the parent entity. This process is represented in FIG. 3. The mechanics of a conceptual indexing process is depicted in FIG. 4. Additionally, a document may be indexed to multiple parent entities if identified in multiple searches so it is discoverable during further review of any of the parent entities to which it is relevant.

Now with reference to FIG. 3, an embodiment initiates with the user entering a search query composed of a WORD (the parent entity). The system searches across all languages of interest for representations of the parent entity. From the entered query, a branch and sequel ontology is developed that includes derivations, dialect and semantics to ensure the expression is correctly captured across all languages. For each language of interest, the process identifies the ontology associated with the parent entity. The collected WORDs together form the search set for use in searching the data sources. A search of the data sources is then made using the search set and data sources containing one of the ontology matches are stored. Retrieved documents are indexed to the parent entity to facilitate efficient searching and to ensure the parent entity is associated with the document instead of the ontology sub-word. Therefore, the result is searchable data set of documents based on the parent entity spanning all available languages of interest. This provides an improvement in the returned search results for computer search systems.

### Example

To improve the comprehension of the process described above, the following example provides an exemplary use case of an embodiment.

At the time of the present disclosure, the Islamic State of Iraq and Syria (ISIS) is a mainstream concern for the United States and other nations. Searching for the term ISIS across languages presents challenges due to its representations in different cultures and the inability of tradition translation methods to capture these variants. Additionally, the term is an acronym but also is recognized as a proper noun. If a user were to enter the term “ISIS” into an engine performing searches across languages the term is still represented as “ISIS.” Even when converting to the primary alphabet of other languages (ex. Cyrillic or Arabic) the response is still a single word.

For example, GOOGLE TRANSLATE and SYSTRAN form the backbone for the majority of translation tools easily available to consumers. The translation of the entity “ISIS” into Russian and Croatian yields in both cases simply “ISIS.”

Using these translated forms of the entity will produce results but only when “ISIS” appears in a document. The drawback for this is that the term can be represented quite differently and without proper correlation a large amount of data will go unobserved. Overcoming this problem is one advantage of the disclosed method.

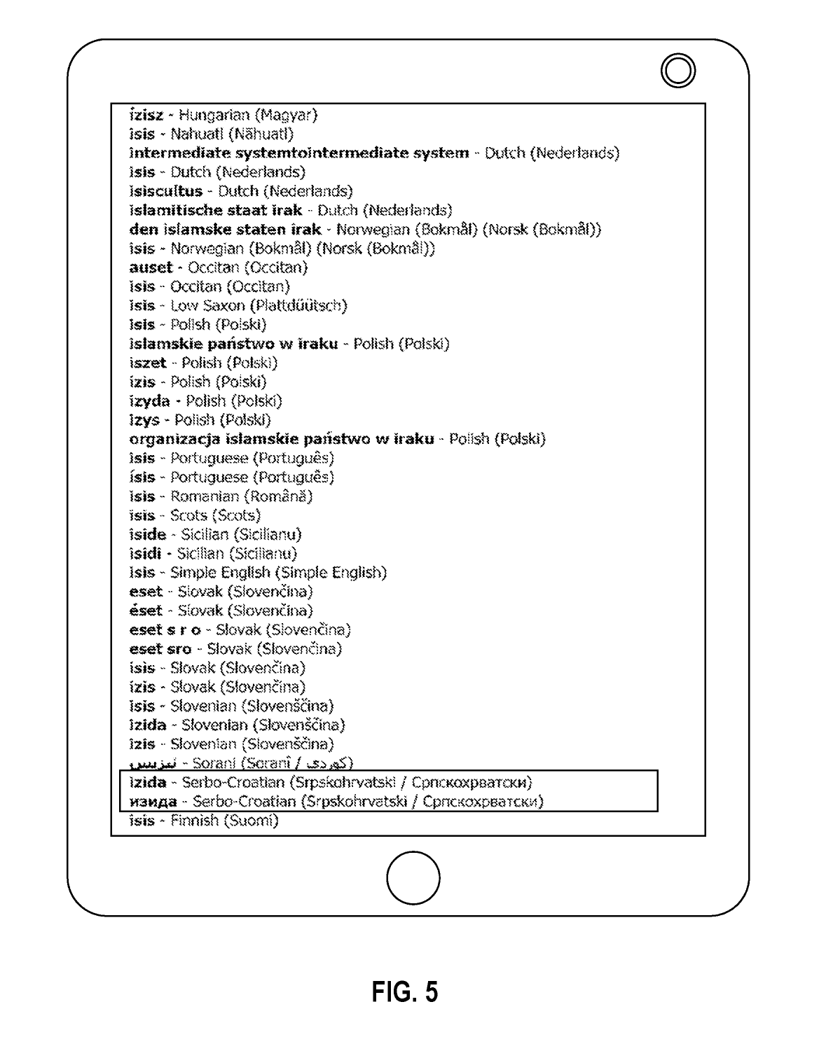

Embodiments use an ontology to capture the representations that a WORD may have within other languages. This ensures that an exhaustive search of available sources will contain the greatest number of relevant documents. FIG. 5 depicts an ontology for ISIS that contains some of the representations of “ISIS” across languages, with Croatian representations highlighted, as presented on a display (in FIG. 5, a tablet, but other electronic displays will be understood to be compatible with the disclosed subject matter).

Croatians typically use the phonetic spelling of ISIS in their own dialect but also the spelling in Cyrillic. In previous systems the translation tools would have overlooked documents containing this subtle difference. The disclosed method would identify these items as possessing the same usage as the searched entity because a comprehensive ontology mapping of equivalents is developed for use in searching. Specifically, on at least one computer readable storage medium, a plurality of language sets are stored. In each language set, a WORD from another language will be associated with (indexed) its equivalents in that language. When a processor receives a query containing a parent entity, it retrieves from each language set the indexed equivalents, and combines those equivalents into an ontology mapping. Afterwards, the processor searches another database searching for results based on the ontology mapping.

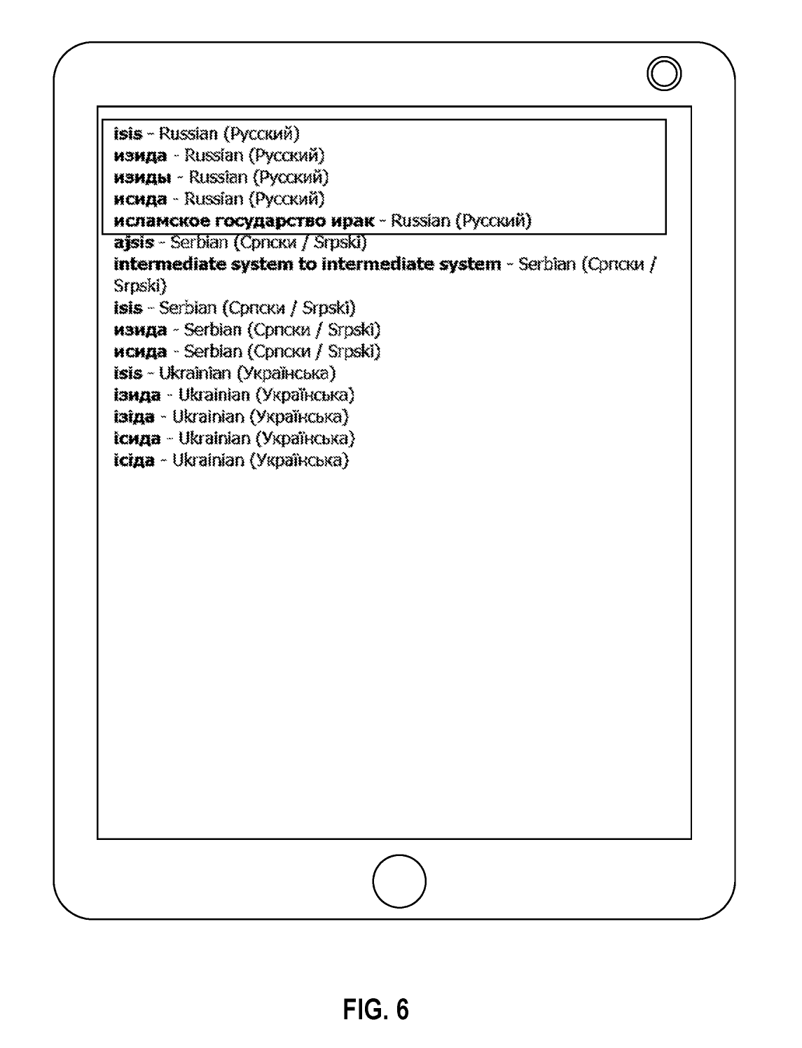

FIG. 6 depicts the ontology representations for ISIS, with the Russian equivalents highlighted.

The Russian ontology representations contain many representations for ISIS in its primary alphabet, Cyrillic. Therefore, in this instance while the translation tools would search for a single translation of the entity, the proposed method would search for five different versions of the term, 1 Latin alphabet spelling (the same as the other tools) plus the four Cyrillic versions.

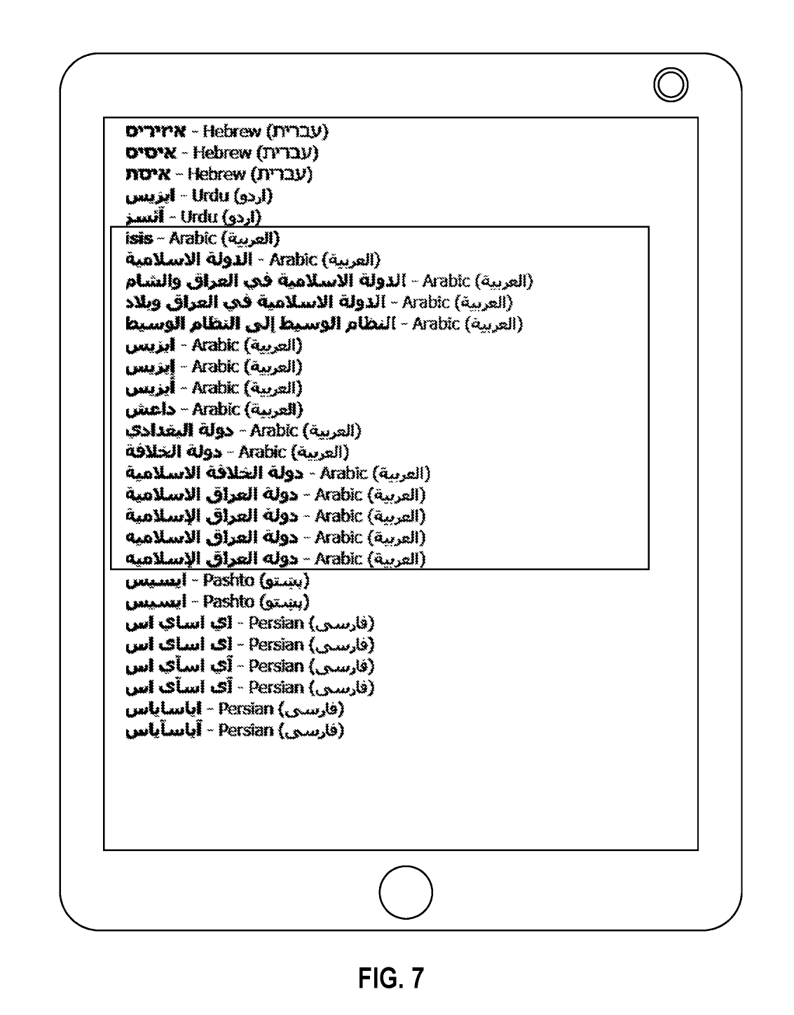

FIG. 7 depicts the ontology representations for “ISIS” with Arabic highlighted.

Using direct translation tools the translation into Arabic abjad of ISIS does not account for many manifestations of “ISIS” found in Arabic communications. The disclosed would, however, identify those representations and use them in searching for relevant documents.

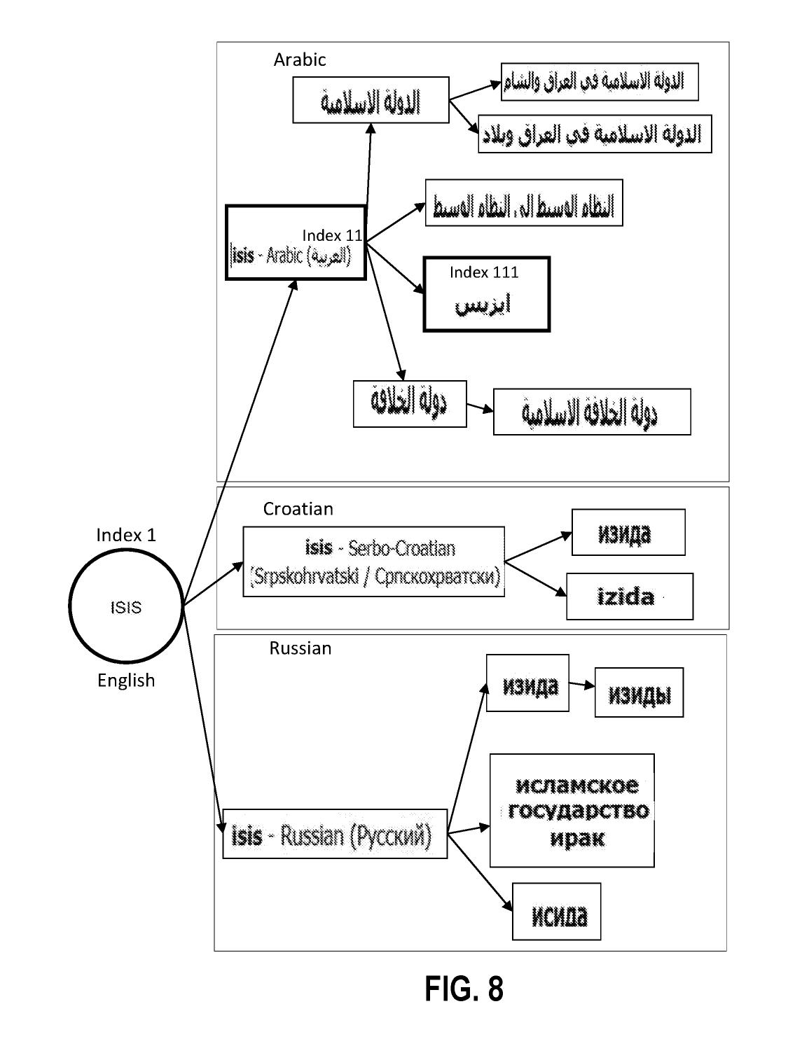

FIG. 8 depicts the building of an ontology mapping for a search query. In the example, the entered search query is “ISIS,” which is mapped to various equivalents in different languages. Some equivalents have additional further equivalents, as can be seen in each of Arabic, Croatian and Russian. All of these equivalents are identified for each language of interest. When the search is complete, the located document is indexed back to the original search query. In the example, the document containing the word [symbol] is now associated with the parent entity for “ISIS” (index 1) even though the document does not contain the actual base word “ISIS.” Thereafter, the document is available for review of materials related the search query.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A method of cross lingual searching, comprising the steps of:
storing on a non-transient computer readable storage a plurality of equivalent representations to a WORD in a plurality of languages;
wherein the equivalent representations include at least one non-direct-translation equivalent representation.
receiving a query having the WORD;
retrieving from the storage medium the equivalent representations of the WORD and forming a search set; and
conducting a search of at least one data source according to the search set.

2. The method of claim 1 further comprising the step of:
storing the results of the search.

3. The method of claim 2 further comprising the step of:
indexing the results of the search to the WORD.

4. The method of claim 1 wherein the non-direct-translation equivalent representation is one of a derivation, dialect and semantic equivalent term or phrase.

5. The method of claim 1 wherein at least one of the languages is a pictographic language.

6. The method of claim 1 wherein the data source is a network.

7. A method of cross-lingual searching, comprising the steps of:
providing non-transient computer-readable storage;
for each of a plurality of languages, storing an ontology mapping of a WORD to equivalent representations;
receiving a parent entity containing the WORD;
retrieving from storage the equivalent representation ontology matches for the WORD from each of the languages;
combining the equivalent representation ontology matches from each of the languages to form a search set;
searching at least one data source and identifying documents containing at least one of the equivalent representation ontology matches; and
storing the identified documents; and
indexing the identified documents to the parent entity.

8. The method of claim 7 wherein one of the equivalent representations is one of a derivation, dialect and semantic equivalent term or phrase.

9. The method of claim 7 wherein the parent entity contains a plurality of keywords and the search set includes equivalent representation ontology matches for each of the keywords.

10. A system for cross-lingual searching, comprising:
an amount of non-transient computer-readable storage medium;
wherein the storage medium has stored thereon an ontology mapping of a search term to equivalent representations for each of a plurality of languages;
a processor configured to:
receive a parent entity containing the search term;
retrieve from the storage medium the equivalent representation ontology matches for the search term from each of the languages;
combine the equivalent representation ontology matches from each of the languages to form a search set;
search at least one data source and identify documents containing at least one of the equivalent representation ontology matches; and
store the identified documents; and
index the identified documents to the parent entity.

11. The system of claim 10 wherein one of the equivalent representations is one of a derivation, dialect and semantic equivalent term or phrase.

12. The system of claim 10 wherein the parent entity contains a plurality of keywords and the search set includes equivalent representation ontology matches for each of the keywords.

13. The system of claim 10 wherein the data source is a network.
